(19) United States
(12) Patent Application Publication
(10) Pub. No.: US 2024/0330061 A1
(43) Pub. Date: Oct. 3, 2024

(54) SYSTEMS AND METHODS FOR PRIORITIZING AND ASSIGNING THREADS IN A HETEROGENEOUS PROCESSOR ARCHITECTURE

(71) Applicant: QUALCOMM INCORPORATED, SAN DIEGO, CA (US)

(72) Inventors: Premal SHAH, San Diego, CA (US); Abhijeet DHARMAPURIKAR, San Diego, CA (US); Kishore Sri Venkata Ganesh BOLISETTY, San Diego, CA (US); Abhimanyu GARG, San Diego, CA (US)

(21) Appl. No.: 18/620,957

(22) Filed: Mar. 28, 2024

Related U.S. Application Data
(60) Provisional application No. 63/493,140, filed on Mar. 30, 2023.

(51) Int. Cl. G06F 9/50

(52) U.S. Cl. CPC G06F 9/5033; G06F 9/5038

(57) ABSTRACT

A method and system for prioritizing and assigning threads in a heterogenous CPU architecture includes receiving input to create frames on a display device of a PCD. Next, threads of execution responsible for creating the frames and which correspond to a number of first CPU cores in the CPU architecture are identified. The CPU architecture includes first CPU cores and second CPU cores, where each first CPU core has a first processing capacity and each second CPU core has a second processing capacity. The first processing capacity is greater than the second processing capacity. For a predetermined time period, a ranking of the threads according to their workload levels is created. And then a present workload level of each first CPU core is determined. A ranking of the first CPU cores according to their present workload levels is created followed by assigning each thread to a single first CPU core.

### DESCRIPTION OF THE RELATED ART

Portable computing devices (e.g., cellular telephones, smart phones, tablet computers, portable digital assistants (PDAs), virtual reality (VR), and portable game consoles) continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising one or more chip components embedded on a single substrate (e.g., one or more central processing units (CPUs), a graphics processing unit (GPU), digital signal processors, etc.).

Such portable computing devices or other computer systems or devices may comprise a multi-cluster heterogeneous processor architecture, an example of which is referred to as a “big.LITTLE” heterogeneous CPU architecture. The “big.LITTLE” and other heterogeneous architectures typically comprise a group of processor cores in which a set of relatively slower, lower-power processor cores are coupled with a set of relatively more powerful processor cores.

For example, a set of processors or processor cores with a higher performance ability are often referred to as the “Big cluster” while the other set of processors or processor cores with minimum power consumption yet capable of delivering appropriate performance (but relatively less than that of the Big cluster) is referred to as the “Little cluster.”

A CPU scheduler may schedule tasks to be performed by the Big cluster or the Little cluster according to performance and/or power requirements, which may vary based on various use cases. The Big cluster may be used for situations in which higher performance is desirable (e.g., graphics, gaming, etc.), and the Little cluster may be used for relatively lower power user cases (e.g., text applications, streaming music).

Existing multi-cluster heterogeneous processor architectures, however, may not effectively optimize performance/power in certain use cases, such as with display intensive and power consuming applications (i.e. gaming applications (on mobile, tablets, VR headsets)). Such applications can be problematic for portable computing devices running on battery power since there will always be at least two competing factors for supporting these applications: performance vs. power conservation.

Accordingly, there is a need in the art for systems and methods for scheduling and managing display frame rendering tasks with optimized performance and power conservation in portable computing devices that have multi-cluster heterogeneous processor architectures.

### SUMMARY OF THE DISCLOSURE

Various embodiments of methods, systems, and computer programs are disclosed for prioritizing and assigning threads in a CPU architecture.

A method for prioritizing and assigning threads in a CPU architecture may include: receiving input to create frames on a display device of battery-powered portable computing device at a predetermined rate; and identifying threads of execution responsible for creating the frames and which correspond to a number of first CPU cores in the CPU architecture. The CPU architecture may have first CPU cores and second CPU cores, where each first CPU core has a first processing capacity and each second CPU core has a second processing capacity. The first processing capacity may be greater than the second processing capacity. For a predetermined time period, a ranking of the threads is created according to their workload levels. Next, a present workload level may be determined for each first CPU core. A ranking of the first CPU cores according to their present workload levels may then be created. Each thread may be assigned to a single first CPU core according to the ranking of the first CPU cores and according to the ranking of the threads.

A system for prioritizing and assigning threads in a CPU architecture may include a scheduler for receiving input to create frames on a display device of battery-powered portable computing device at a predetermined rate. The scheduler may identify threads of execution responsible for creating the frames and which correspond to a number of first CPU cores in the CPU architecture. The CPU architecture may include first CPU cores and second CPU cores, where each first CPU core has a first processing capacity and each second CPU core has a second processing capacity. The first processing capacity is usually greater than the second processing capacity. For a predetermined time period, the scheduler may create a ranking of the threads according to their workload levels. The scheduler may then determine a present workload level of each first CPU core. The scheduler may also create a ranking of the first CPU cores according to their present workload levels. The scheduler may then assign each thread to a single first CPU core according to the ranking of the first CPU cores and according to the ranking of the threads.

A system for prioritizing and assigning threads in a CPU architecture may include a scheduler for receiving input to create frames on a display device of a battery-powered portable computing device at a predetermined rate. The scheduler may identify threads of execution responsible for creating the frames and which correspond to a number of first processing means in the CPU architecture. The CPU architecture may include first processing means and second processing means, where each first processing means has a first processing capacity and each second processing means has a second processing capacity. The first processing capacity is generally greater than the second processing capacity. For a predetermined time period, the scheduler may create a ranking of the threads according to their workload levels. The scheduler may determine a present workload level of each first processing means. The scheduler may also create a ranking of the first processing means according to their present workload levels, and the scheduler may assign each thread to a single first processing means according to the ranking of the first processing means and according to the ranking of the threads. The first and second processing means may each include processing clusters.

A non-transitory computer program product for prioritizing and assigning threads in a CPU architecture may include instructions that when executed by CPU architecture configure the CPU architecture to: receive input to create frames on a display device of a battery-powered portable computing device at a predetermined rate and identify threads of execution responsible for creating the frames and which correspond to a number of first CPU cores in the CPU architecture. The CPU architecture may have first CPU cores and second CPU cores, where each first CPU core has a first processing capacity and each second CPU core has a second processing capacity. The first processing capacity is usually greater than the second processing capacity. For a predetermined time period, the instructions may cause the CPU architecture to create a ranking of the threads according to their workload levels and determine a present workload level of each first CPU core. A ranking of the first CPU cores may be created according to their present workload levels and each thread may be assigned to a single first CPU core according to the ranking of the first CPU cores and according to the ranking of the threads.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a functional block diagram illustrating how a completely fair scheduler of a high-level operating system (HLOS) of a portable computing device (PCD) manages threads of execution for rendering frames on a display device for a gaming computer application running on the PCD;

FIG. 2A is a functional block diagram of an embodiment of a system comprising a multi-cluster heterogeneous processor architecture for prioritizing and assigning pipeline threads to single dedicated cores during a vSync window, where the system has a single prime core;

FIG. 2B is a functional block diagram of another embodiment of a system comprising a multi-cluster heterogeneous processor architecture for prioritizing and assigning pipeline threads to single dedicated cores during a vSync window, where the system does not have any prime cores;

FIG. 2C is a functional block diagram of another embodiment of a system comprising a multi-cluster heterogeneous processor architecture for prioritizing and assigning pipeline threads to single dedicated cores during a vSync window, where the system has two prime cores;

FIG. 3A illustrates a flowchart of a method in accordance with an embodiment for prioritizing and assigning pipeline threads to single dedicated cores of a CPU architecture during a vSync window;

FIG. 3B-1 illustrates a continuation flowchart of the method of FIG. 3A in accordance with an embodiment for prioritizing and assigning pipeline threads to single dedicated cores of a CPU architecture during a vSync window;

FIG. 3B-2 illustrates a continuation flowchart of the method of FIG. 3B-1 in accordance with an embodiment for prioritizing and assigning pipeline threads to single dedicated cores of a CPU architecture during a vSync window;

FIG. 3C illustrates a continuation flowchart of the method of FIG. 3A in accordance with an embodiment for prioritizing and assigning pipeline threads to single dedicated cores of a CPU architecture during a vSync window;

FIG. 4A illustrates CPU utilization for two big-CPU cores and a single prime core of FIG. 2A using conventional thread assignment technology in accordance with an embodiment;

FIG. 4B illustrates CPU utilization for two big-CPU cores and a single prime core of FIG. 2A using the method of FIG. 3; and

FIG. 5 illustrates an example of a battery-powered portable computing device, such as a mobile telephone, which executes the method of FIG. 3 for prioritizing and assigning pipeline threads to single dedicated cores of a CPU architecture during a vSync window.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

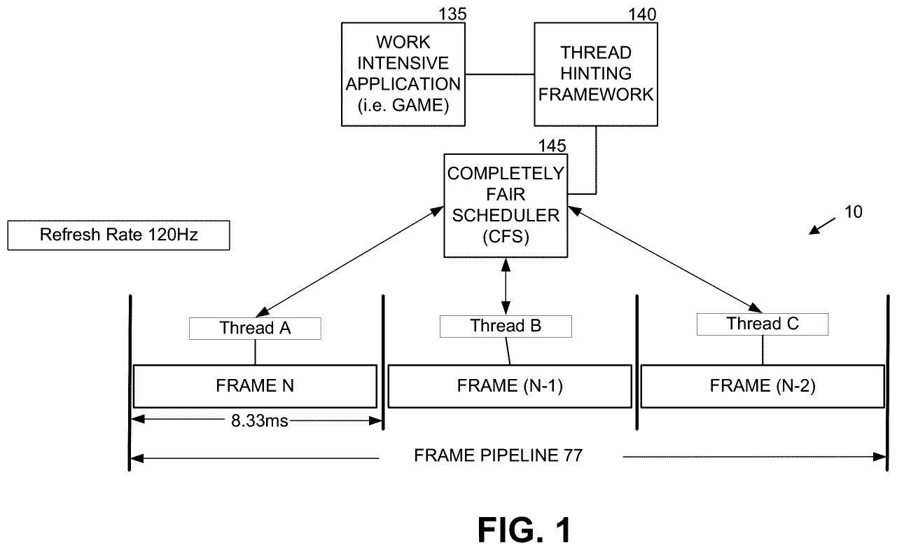

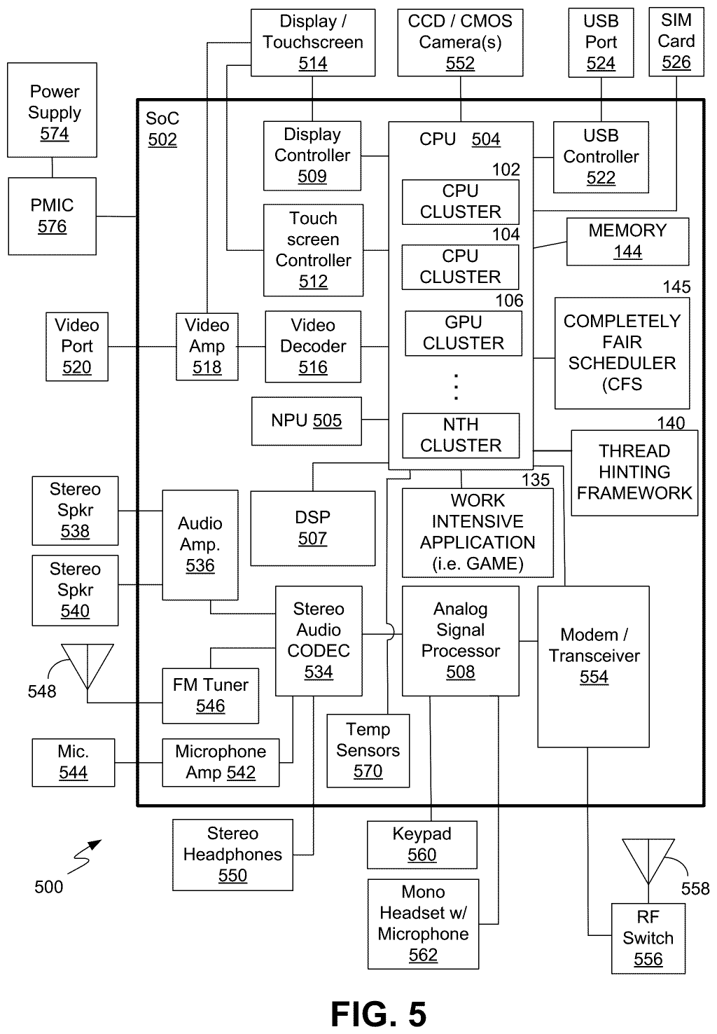

Referring now to FIG. 1, this figure is a functional block diagram illustrating how a completely fair scheduler of a high level operating system (HLOS) of a portable computing device (PCD) 500 (see FIG. 5) manages threads of execution A, B, & C for rendering frames (N, N−1, N−2) on a display device 514 (see FIG. 5) for a gaming computer application 135 running on the PCD 500. As shown in FIG. 1, most gaming workloads associated with a gaming application 135 running on the PCD 500 have at least two or three key CPU threads (A, B, C) that wakeup periodically every display refresh interval on the display device 514, known to one of ordinary skill in the art as vertical sync (vSync).

The term, “vSync,” often refers to how the frame rate of a gaming application is synchronized with a gaming monitor's refresh rate (i.e. 8.33 ms interval for a 120 Hz display panel). The workloads for these two or three pipeline threads (A, B, & C) are generally required to be completed within the display vSync time budget (i.e. 8.33 ms) to meet the desired gaming frames-per-second (fps) rate (i.e. 120 fps rate). These threads A, B, & C are managed by a completely fair scheduler (CFS) 145 which is part of the High Level Operating System (HLOS) for the PCD 500. This CFS 145 will be described in more detail below.

These key periodic per-frame CPU threads A, B, & C for display frame rendering is known to one of ordinary skill in the art as frame pipeline threads/tasks (A, B, & C). The CPU workload for a given frame (N, N−1, N−2) is essentially split into these pipeline threads (A, B, & C); while all these pipeline threads (A, B, & C) run concurrently every vSync (here .g., 8.33 ms for a frame rate of 120 Hz).

For a computer gaming application running on a PCD 500 with three pipeline threads (A, B and C), the way the frame pipeline 77 on the CPU 500 is architected is usually as follows: while thread-A is working on frame (N); thread-B will be working concurrently on frame (N−1); thread-C will be working concurrently on frame (N−2).

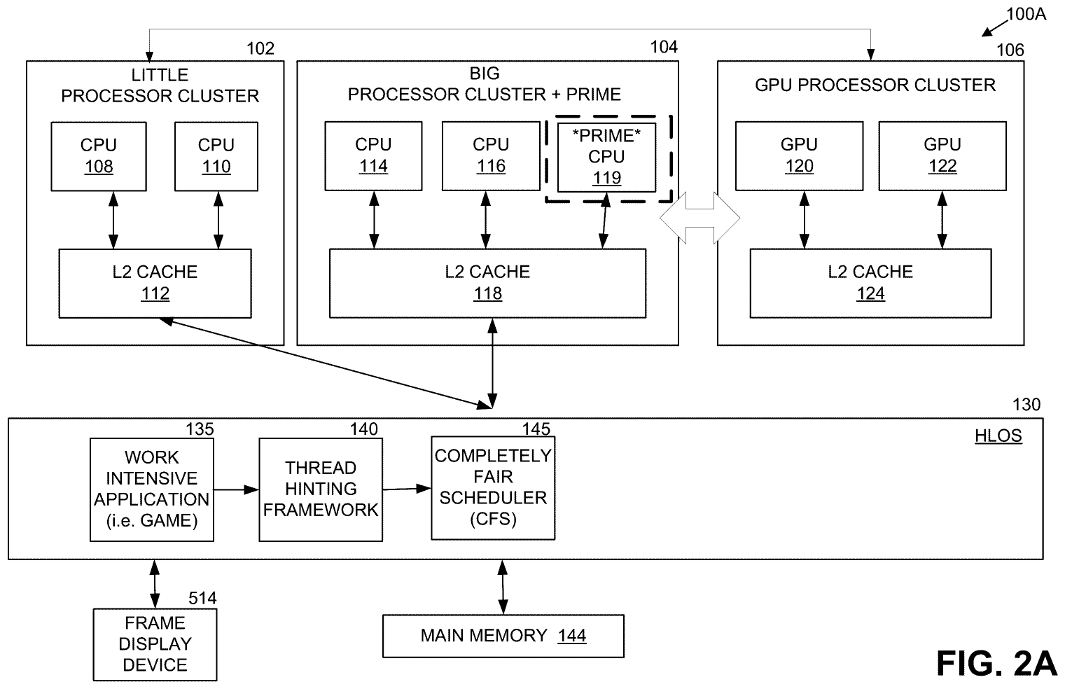

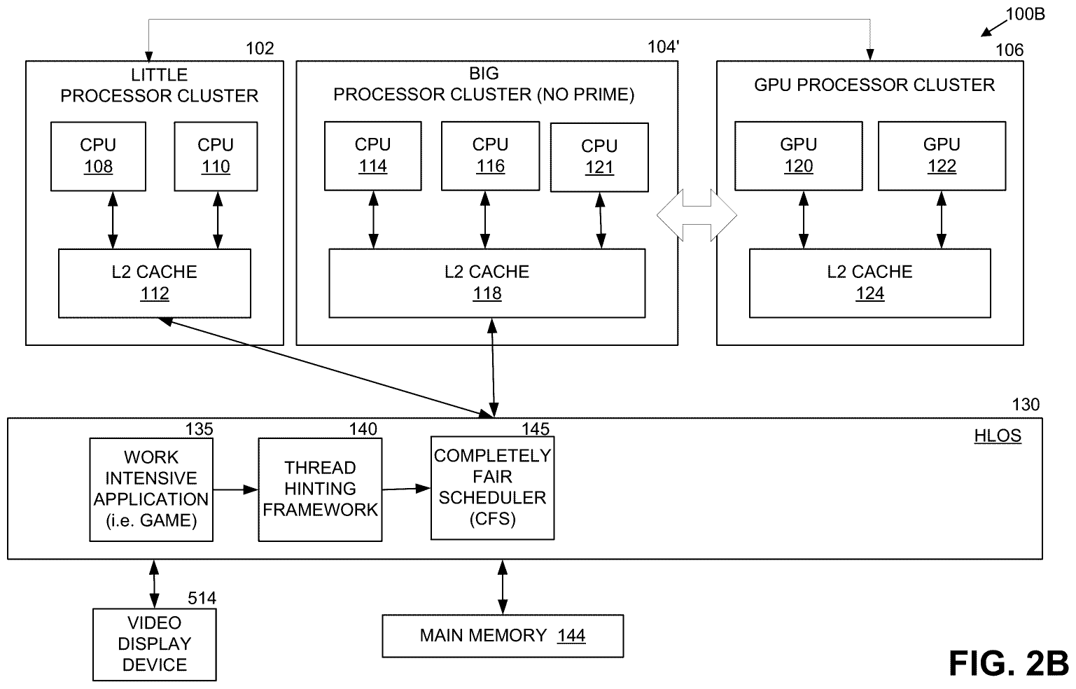

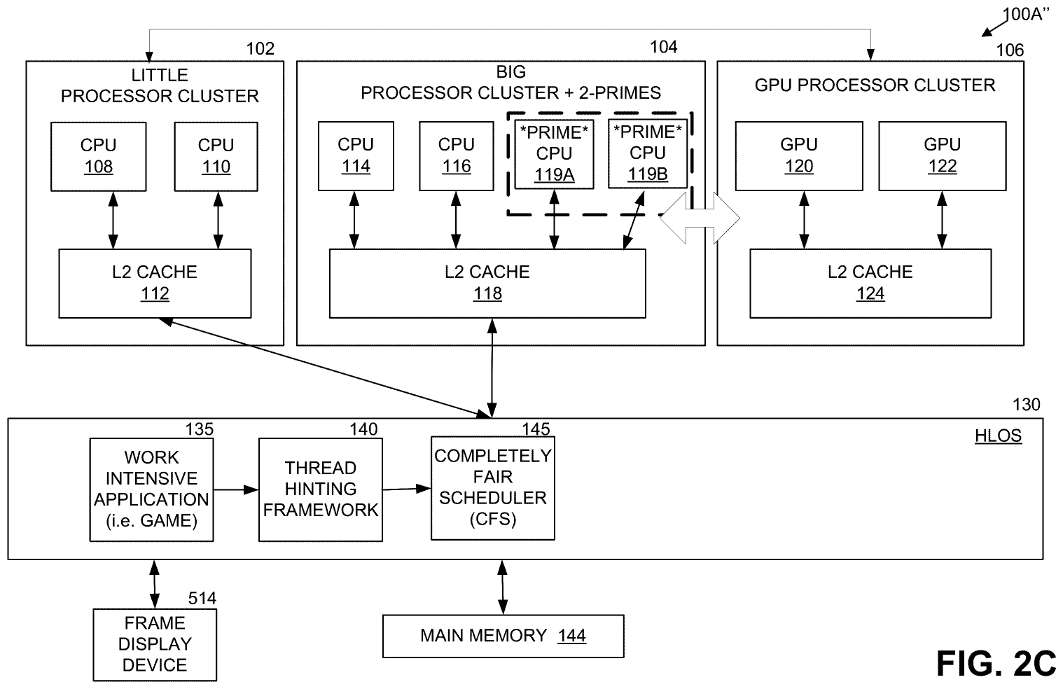

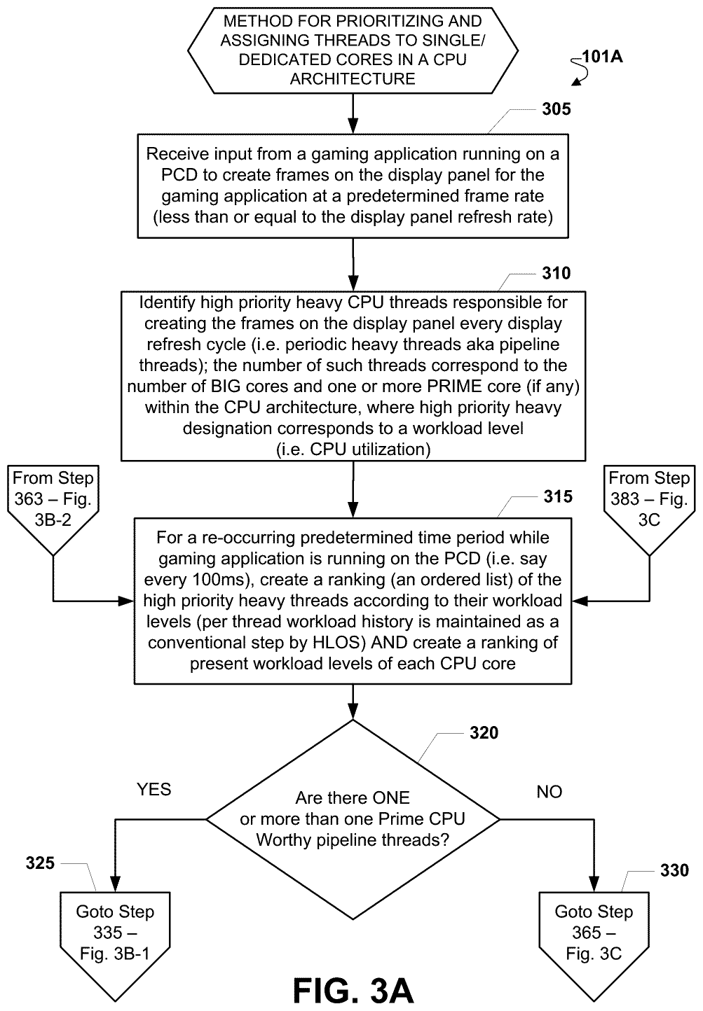

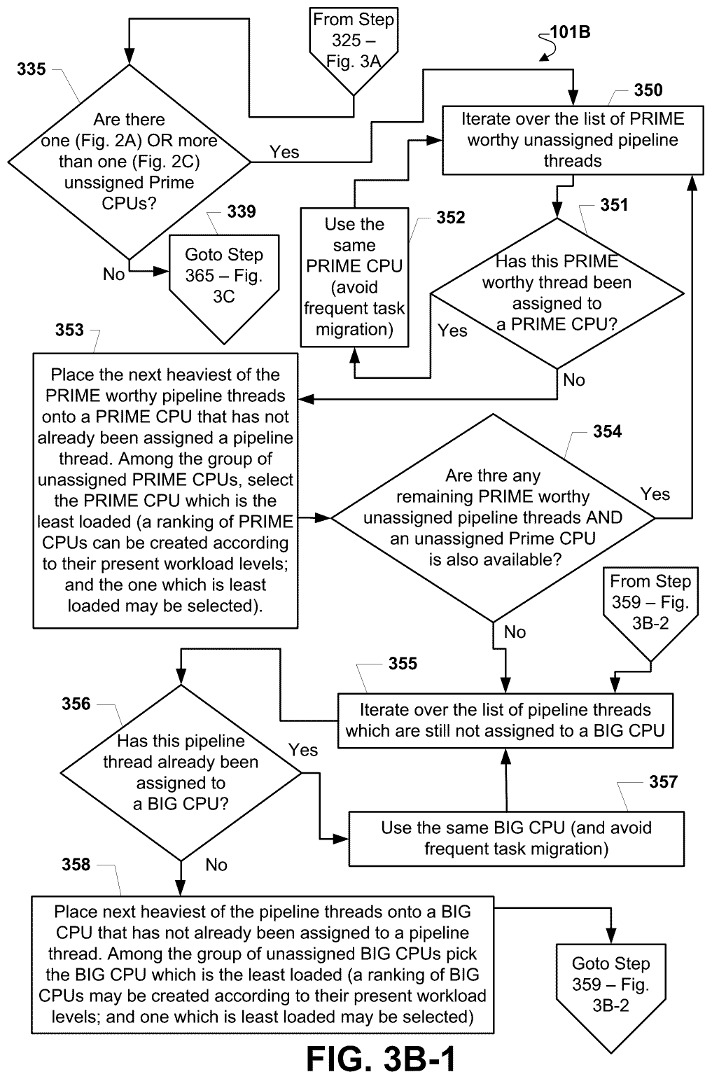

Once thread-C completes its share and the last stage of CPU work; it then submits its frame (N−2) to the graphics processing unit (GPU) 102 (See FIGS. 2A-2B-GPU cluster 102) to complete the final hardware (HW) (i.e. GPU) accelerated frame rendering. Once a GPU 102 completes the frame rendering, it then will signal the display device (514—See FIG. 5) to show/display the newly rendered frame onto the display device 514 at the start next vSync window.

The background section listed above generally mentions one of the problems of the prior art which includes balancing performance with power in supporting the gaming application 135, especially when the PCD 500 is running on battery power. One of the specific problems of the prior art is if one of the pipeline threads (i.e., A, B, or C) does not complete its share of CPU work timely within the vSync budget (e.g., 8.33 ms for a frame rate of 120 Hz), that particular thread (A, B, or C) may lead to a frame drop or Janks.

HLOS for PCDs 500, like ANDROID™ brand and APPLE™ HLOS, usually have a large/significant CPU task density for a given gaming application 135 (e.g., on the order of about 35 tasks or more for a gaming application 135). Typical gaming applications 135 known as of this writing include, but are not limited to, GENSHIN™/HOK™/FORTNITE™ brand games.

All of the threads/tasks A, B & C to support these gaming applications 135 need to be served timely on the CPUs 102, 104 (see FIGS. 2A-2B) of a PCD 500 within a given SoC 502. This work is managed by the completely fair scheduler (CFS) 145 noted above that is usually present within a HLOS for a PCD 500, like the ANDROID™ brand HLOS known as of this writing.

Pipeline threads A, B, & C of the conventional art usually do not have deterministic CPU scheduling from the HLOS despite the significant volume of tasks/threads A, B, & C on the operating system. Deterministic scheduling in the prior art is generally not used because the HLOS CFS 145 is designed as a general purpose framework and it usually does not know that display frame rendering tasks will periodically wake up and run concurrently on a per-frame basis, as illustrated in FIG. 1.

The HLOS CFS 145 of the prior art usually causes these pipeline threads A, B, & C for display frame rendering to usually hop around multiple CPUs 102, 104 based on the CFS policy (which usually includes a best-effort power efficient scheduling within a big. Little (b.L) system described in more detail below in connection with FIG. 2) which in turn may lead to decreases in CPU instructions per cycle (IPC) with reduced CPU cache temporal locality.

Many times, based on the workload pattern of these pipeline threads A, B, & C, a conventional HLOS CFS 145 may pack and schedule multiple important pipeline tasks/threads A, B, & C onto the same CPU 102, 104 (task packing on a single CPU 102, 104); which in turn can push each CPU 102, 104 to operate at a higher frequency corner resulting in a significantly higher power draw for the PCD 500 running on a limited battery power supply 574 (see FIG. 5).

This higher power draw of the prior art for gaming applications 135 usually results in both inferior performance (frame drops and low fps) and higher power consumption (Watt) by the PCD 500. For high performance gaming applications 135, such as, but not limited to, real-time 3D (RT3D) computer application games 135, higher power draws on the PCD 500 may easily lead to higher heat dissipation and the PCD 500 getting close to or breaching its thermal specifications/limits.

Each gaming application 135 can have a different number/count of pipeline threads A, B, & C. The gaming application 135 can mark these key threads A, B, & C as pipeline threads using popular user space thread hinting frameworks 140 known as of this writing (i.e. ANDROID™ brand operating systems that include ANDROID™ Dynamic Performance Framework (ADPF) application performance interfaces (APIs), and Qualcomm Adaptive Performance Engine (QAPE) APIs). The thread hinting framework 140 is illustrated in FIG. 1 and communicates with the HLOS CFS 145.

A CPU pipeline thread A, B, or C is deemed heavy on a b.L CPU subsystem (See FIGS. 2A-2B) by a CFS 145 and/or thread hinting framework 140 if it cannot be run on the little-CPU 108, 110 (FIGS. 2A-2B) (usually in-order execution CPU for lightweight workloads) to meet its vSync timing requirements per frame. Such threads A, B, or C are usually heavy on CPU Million instructions per second (MIPS) and likewise need to be run on a big-CPU 114, 116, 119 (FIGS. 2A-2B) (usually out-of-order execution CPU) to meet its vSync timing requirements per frame.

The HLOS CFS 145 of FIG. 1 for a b.L CPU subsystem (See FIGS. 2A-2B) manages the task/thread distribution such that heavy CPU threads (A, B, or C) get scheduled onto big-CPUs 114, 116, 119 while the lightweight threads (D, E, or F not illustrated) get scheduled onto little-CPUs 108, 110.

Pipeline threads A, B, & C for high-performance games usually are heavy on CPU MIPS and run on big-CPU cores 114, 116, 119 (in a b.L system shown in FIGS. 2A-2B). Generally, a conventional HLOS CFS 145 may use a prime core 119 (FIG. 2A—described in more detail below) only when a thread A, B, or C breaches a certain workload (CPU utilization threshold) at which point it will be moved to the prime core 119 only to be later moved back to another lower capacity big-Core 114, 116 as soon as its load drops below a predefined load threshold

For example, in the prior art, most often after a task/thread A, B, or C that is moved back from the prime core 119, the prime core 119 (See FIG. 2A) may be instructed to enter into a deep power collapsed state causing flush of all local CPU caches 118, only to be woken up again in a short while for the same heavy pipeline thread A, B, or C; resulting in wasted energy and loss of temporal cache locality.

While this conventional HLOS strategy of CPU core switching generally works sufficiently for a computational bound CPU workload, this conventional HLOS strategy does not scale well/work well for display type threads A, B, or C of FIG. 1 which have heavy CPU workloads.

Thus, opposite to conventional HLOS strategy, and according to one aspect of the system 100 and method 101, each thread A, B, or C is assigned to a single big-CPU core 114, 116, or 119 such that each thread A, B, or C has a single dedicated core 114, 116, or 119 without any switching of cores while a thread A, B, or C is being processed during a vSync/schedular accounting window.

For this exemplary aspect, it is noted that pipeline threads A, B, or C may be switched to a different core 114, 116, 119 after the expiration of a vSync window (i.e. after 8.33 ms @ 120 Hz). According to another aspect, when a prime core 119 exists in a CPU architecture (see FIG. 2A), the heaviest pipeline thread (A, B, or C) for a vSync window as determined by the CFS 145 with help from the thread hinting framework 140 may be assigned by the CFS 145 to the prime core 119 for the vSync window. Other exemplary aspects of the system 100 and method 101 will be described in further detail below.

Referring now to FIG. 2A, this figure is a functional block diagram of an embodiment of a system 100A comprising a multi-cluster heterogeneous processor architecture for prioritizing and assigning pipeline threads A, B, & C to single dedicated cores 114, 116, 119 during a vSync/Schedular accounting window. The system 100A may be implemented in any computing device 500 (see FIG. 5), including a personal computer, a workstation, a server, a portable computing device (PCD), such as a cellular telephone, a portable digital assistant (PDA), a portable game console, a palmtop computer, or a tablet computer.

The multi-cluster heterogeneous processor architecture comprises a plurality of processor clusters 102, 104 in communication with a completely fair scheduler 145 of a HLOS 130. As known in the art, each processor cluster 102, 104, 106 may comprise one or more processors or processor cores (e.g., central processing units (CPUs) 108, 110, 114, 116, 119, graphics processing units (GPUs) 120, 122, digital signal processor (DSP) 507—See FIG. 5, etc.) with a corresponding dedicated cache 112, 118, 124. It is noted that the CPU clusters 104, 106 may communicate with the GPU cluster 106 at the hardware level though regular hardware interrupts as understood by one of ordinary skill in the art.

In the exemplary embodiment of FIG. 2A, the processor clusters 102 and 104 may comprise a “big.LITTLE” heterogeneous architecture, as described above, in which the processor cluster 102 comprises a Little cluster and the processor cluster 104 comprises a Big cluster. The Little processor cluster 102 comprises a plurality of central processing unit (CPU) cores 108 and 110 which are relatively slower and consume less power than the CPU cores 114, 116, 119 which are in the Big processor cluster 104.

It should be appreciated that the Big cluster CPU cores 114, 116, 119 may be distinguished from the Little cluster CPU cores 108 and 110 by, for example, a relatively higher instructions per cycle (IPC), higher operating frequency, and/or having a micro-architectural feature that enables relatively more performance but at the cost of additional power. Furthermore, additional processor clusters may be included in the system 100, such as, for example, a processor cluster 106 comprising GPU cores 120 and 122.

The Big processor cluster may further comprise one or more prime core CPU 119. This prime core CPU 119 may have relatively higher instructions per cycle (IPC), a higher operating frequency, and/or one or more micro-architectural features that enable relatively more performance than its neighboring big cores 114, 116 but at the cost of additional power consumption. That is, the prime core CPU 119 may have the highest IPC capacity and highest power consumption compared to its two neighboring big cores 114 & 116.

The system 100A is not limited to two small CPU cores 108, 110 and two big CPU cores 114, 116, and the single prime CPU core 119. Additional or fewer CPU cores (i.e. more than two big CPU cores or more than one prime CPU core) are possible and are included within the scope of this disclosure.

Each processor cluster 102, 104, and 106 may have an independent cache memory 112, 118, 124 used by the corresponding processors in the system 100 to reduce the average time to access data from a main memory 144. In an embodiment, the independent cache memory 112, 118, 124 and the main memory 144 may be organized as a hierarchy of cache levels (e.g., level one (L1), level two (L2), level three (L3). Processor cluster 102 may comprise L2 cache 112, processor cluster 104 may comprise L2 cache 118, and processor cluster 106 may comprise L2 cache 124.

The completely fair scheduler (CFS) 145 is part of a high-level operating system (HLOS) 130 as described previously in connection with FIG. 1. The HLOS CFS 130 is responsible for managing the pipeline threads A, B, C of the frame pipeline 77. Specifically, the HLOS CFS 130 instructs which heavy pipeline threads A, B, & C are assigned to each of the two big cores 114, 116 and the single prime core 119. The HLOS CFS 130 may maintain an ordered/ranked list for the pipeline threads A, B, & C, where the workload size of each thread may be determined by the thread hinting framework and the HLOS CFS 130.

More specifically, the HLOS CFS 130 may create a ranked/ordered list of the threads A, B, & C marked as workload heavy pipeline threads (i.e. heavy-pipeline-threads hinted from the hinting framework 140). The heaviness of a pipeline thread A, B, & C may be characterized as a proxy to how long each thread is going to take to complete its work on the highest capacity big-CPU, which is the single prime core 119 for the system 100A illustrated in FIG. 2A.

The highest-capacity big-CPU in the CPU subsystem 104, which is referred to as the single “prime” core 119 of the CPU cluster 104, is the one that also gives the best CPU IPC for a given CPU workload at ISO-CPU frequency (iso-prefix means equal) across all the other big cores 114, 116 in the CPU cluster and usually also has a higher CPU-fMax corner (i.e., the maximum allowed CPU frequency) compared to other big-CPUs 114, 116 in the CPU subsystem 104.

The heavier the pipeline thread A, B or C, the more time it is usually going to take to complete its share of per frame CPU work. Because of the CPU IPC advantage of the single or multiple prime core (micro-architecture advantage and usually a larger CPU cache 118), the inventors have observed that the heaviest thread A, B, or C will run at a relatively lower CPU frequency corner as compared to the same thread running on big core 114, 116 of the CPU cluster 104, which results in significant power benefits for the same performance.

Thus, according to one exemplary aspect of the system 100A, the HLOS CFS 130 will always instruct the single heaviest pipeline thread A, B, or C from its ordered/ranked list of threads to be executed by the highest capacity prime core 119. As the game scene being displayed on the display device 514 of the PCD 500 changes, the relative heaviness ordering of these pipeline threads A, B, or C can easily change from one scene to next; and so, does the placement onto the prime core 119 and two big cores 114, 116.

Generally, as basis of comparison and opposite to system 100A, a conventional HLOS CFS 130 will typically use the prime core 119 only when a thread A, B, or C breaches a certain workload (CPU utilization) threshold. Once the workload threshold of the conventional system is breached, the CFS 130 will move the thread (i.e. A, B, or C) to the prime core 119 only to be later moved back to another lower capacity big-Core 114, 116 as soon as its workload drops below the predefined workload threshold and where this switching between cores 114, 116 or 119 may occur during a vSync window.

Meanwhile, opposite to conventional technology, the method 101 and system 100 described herein usually avoids this back-and-forth migration across big cores 114, 116 and/or prime core 119 and instead, keeps each pipeline thread A, B, or C dedicated to a single core (114, 116, or 119).

According to the system 100A of FIG. 2A and method 101, the HLOS CFS 145 assigns the heaviest (work-heavy) pipeline thread (A, B, or C) from its ordered list to the single prime core 119 if, and only if, it is deemed prime worthy. A pipeline thread is deemed and marked as prime worthy if it no longer can complete its per-frame work within the vSync boundary at the big-core 114, 116 CPU Fmax; as evaluated in the most recent vSync window.

Once a pipeline thread is marked as Prime worthy, the system 100 may choose to have a hysteresis window (a pre-defined time threshold; such as, but not limited to, about 100.0 milliseconds) until which it can host the pipeline thread on the same Prime core 319; which further helps to smoothen out frame to frame workload jitters and also avoid frequent task migration. If the SoC 502 has more than one prime core (i.e. 119A, 119B—See FIG. 2C), then this process repeats for the next in order heavy pipeline thread. The first and heaviest of the pipeline prime-worthy threads will be placed on the least loaded available Prime CPU core 319.

Once all the prime core worthy pipeline threads are assigned to the available number of Prime cores 319, the next heavy pipeline thread (A, B, or C) from its ordered list will then be placed on the next most high-capacity big-core 114 or 116; until all the tasks/threads in list-heavy-pipeline-threads maintained by the CFS 145 are placed onto their respective big cores 114 or 116.

Usually, if there are more than one big core 114, 116 with same CPU capacity (i.e. same CPU micro-architecture and same CPU-fMax), then the CFS 145 will first pick the big-CPU 114 or 116 which is most lightly loaded with respect to all other non-pipeline threads; which in turn allows for even balancing of the overall CPU workload in the system 100A. On certain SoCs 502, the CPU capacity delta on big cores 114, 116 may come from just the CPU-fMax delta of the big cores 114, 116 (while the micro-architecture of all the big cores 114, 116 stay the same).

There is a heavy migration cost associated with these pipeline threads (A, B, or C) (in the list-heavy-pipeline-threads maintained by the CFS 145) such that they will usually (in most occurrences) continue to wake-up on the same big CPU 114, 116 or one or more prime CPU 119, unless their own relative heaviness changes significantly (likely when a game scene changes). The heaviness for these group of pipeline threads A. B, or C is continuously monitored by the HLOS CFS 145 approximately every vSync window (i.e. 8 ms window on a 120 Hz display refresh rate) which ensures that the heaviest of the pipeline threads (A, B, or C) always is served by the highest capacity big-CPU 114, 116 or single or multiple prime cores 119 (if a prime core 119 exists in the CPU architecture 100A).

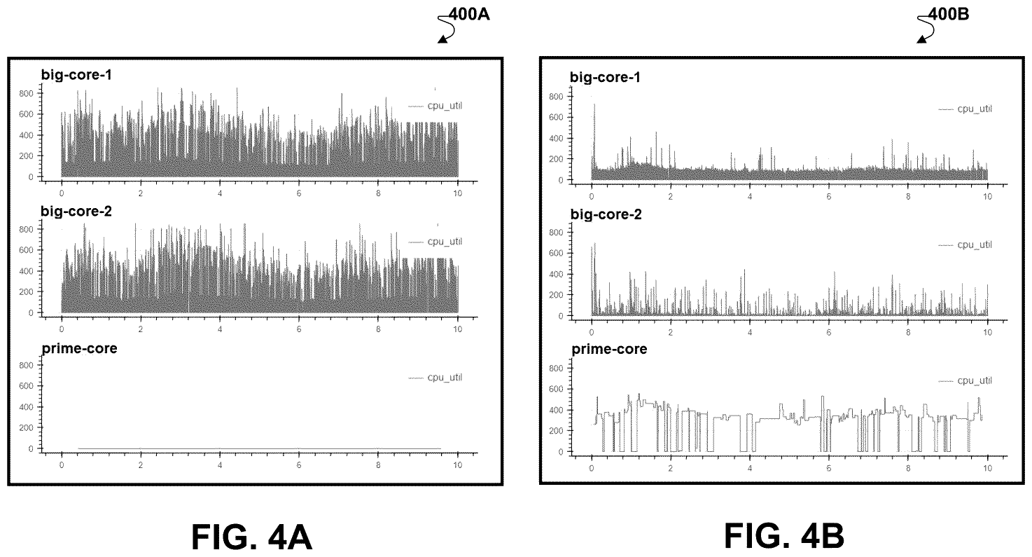

For a given game scene displayed on a display device 514 of the PCD 500, the inventors have observed that the heaviness ranking/ordering of the group of heavy-pipeline threads A, B, or C does not change frequently; and thus, the pipeline thread placement among the cores 114, 116, and 119 of the cluster 104 increases processing efficiency as illustrated in FIGS. 4A-4B described below.

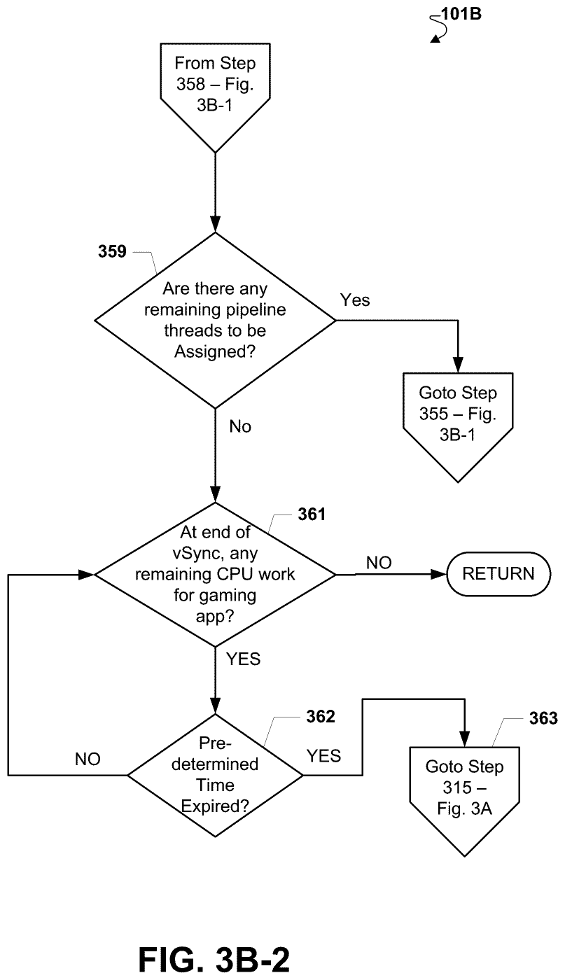

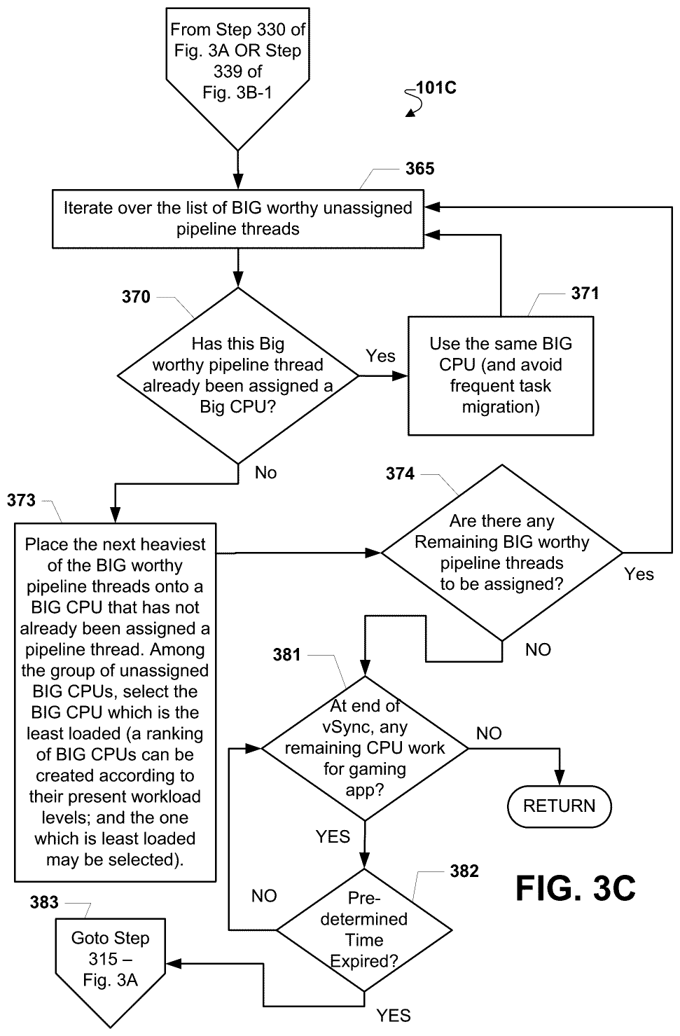

The system 100A of FIG. 2A and method 101 (see FIG. 3) are not a hard CPU affinity but a soft bias to avoid frequent and often unnecessary task migration/load-balancing. Pipeline threads (of A, B, or C) will usually be assigned to a single CPU core 114, 116, or 119. This also results in a much more consistent load pattern across all the big-CPU cores 114, 116, and prime core 119 and significantly lowers load spikes, which in turn results in better SoC power and performance. The method 101 and system 100 may significantly reduce each big CPU's-fMax residency.

FIG. 2B is a functional block diagram of an embodiment of a system 100B comprising a multi-cluster heterogeneous processor architecture for prioritizing and assigning pipeline threads A, B, or C to single dedicated cores during a vSync window. FIG. 2B is substantially similar to the exemplary embodiment illustrated in FIG. 2A. Therefore, only the differences between these two figures will be described below.

One main difference between the multi-cluster heterogeneous processor architecture of system 100A of FIG. 2A and the multi-cluster heterogeneous processor architecture of system 100B of FIG. 2B is that the system 100B does not have a prime core 119 in the big CPU cluster 104′. Instead of having a prime core 119, the big CPU cluster 104′ has another big CPU core 121 which is the same size in processing capacity as the other two big CPU cores 114, 116.

In other words, the three big cores 114, 116, and 121 of the big CPU cluster 104′ have substantially equivalent processing capacities as well as power consumption. However, the system 100B is not limited to two small CPU cores 108, 110 and three big CPU cores 114, 116, and 121. Additional or fewer CPU cores are possible for the system 100B and are included within the scope of this disclosure.

According to one exemplary aspect of the system 100B of FIG. 2B, the HLOS CFS 130 will always instruct the heaviest pipeline thread A, B, or C from its ordered/ranked list of threads to be executed by a big CPU core 114, 116, or 121 with the lightest workload. As the game scene being displayed on the display device 514 of the PCD 500 changes, the relative heaviness ordering of these pipeline threads A, B, or C can easily change from one scene to next; and so, does the thread placement onto the three big cores 114, 116, & 121.

According to the system 100B of FIG. 2B and method 101, once the HLOS CFS 145 assigns the heaviest (work-heavy) pipeline thread (A, B, or C) from its ordered list to the first of the three big CPU cores 114, 116, or 121, the next heavy pipeline thread (A, B, or C) from its ordered list will then be placed on the next big CPU core 114, 116, or 121 with the next lightest workload; until all the tasks/threads in list-heavy-pipeline-threads maintained by the CFS 145 are placed onto the respective big cores 114, 116, or 121. This thread placement among the three big CPU cores 114, 116, or 121 allows for even balancing of the overall CPU workload in the system 100B.

Referring now to FIG. 2C, this figure is a functional block diagram of an embodiment of a system 100C comprising a multi-cluster heterogeneous processor architecture for prioritizing and assigning pipeline threads A, B, or C to single dedicated cores during a vSync window. FIG. 2C is substantially similar to the exemplary embodiment illustrated in FIG. 2A. Therefore, only the differences between these two figures will be described below.

One main difference between the multi-cluster heterogeneous processor architecture of system 100A of FIG. 2A and the multi-cluster heterogeneous processor architecture of system 100C of FIG. 2C is that the system 100C has two prime cores 119A, 119B in the big CPU cluster 104′.

Referring now to FIG. 3A, this figure illustrates a flowchart of a method 101 for prioritizing and assigning pipeline threads A, B, or C to single dedicated cores 114, 116, 119, 121 of a CPU architecture 104, 104′ during a vSync window 77 (FIG. 1). Step 305 is the first step of method 101.

In step 305, the completely fair scheduler 145 may receive input from a gaming application 135 running on a PCD 500 to create frames N, N-1, N-2 (see FIG. 1) on the display device 514 (see FIG. 5) at a predetermined frame rate (i.e. frames per second-fps). The predetermined frame rate is generally less than or equal to the display panel refresh rate.

As noted previously, as of this writing, display devices 514 of PCDs 500 may have a refresh rate of about 120.0 Hz. This translates to about an 8.33 milliseconds (ms) interval to achieve this refresh rate of about 120.0 Hz. Other refresh rates higher or lower are possible and are included within the scope of this disclosure. For example, another common refresh rate as of this writing is 60 Hz, which translates to about a 16.6 ms interval per frame for this refresh rate.

Subsequently, in step 310, a plurality of high priority heavy CPU threads responsible for creating the frames N, N-1, N-2 (see FIG. 1) on the display device 514 every display refresh cycle (i.e. periodic heavy threads a.k.a. pipeline threads) are identified. The number of such threads N, N-1, N-2 generally corresponds to the number of BIG cores 114, 116, 121 and one or more PRIME cores 119 (if any) within the CPU Architecture 104, 104′.

The high priority heavy designation generally corresponds to a workload level, meaning that the heaviest thread in terms of CPU workload will have the highest priority and the lightest thread in terms of CPU workload will have the lowest priority. This workload priority generally corresponds with CPU utilization as understood by one of ordinary skill in the art.

This step 310 is generally performed by the completely fair scheduler (CFS) 145 running on a CPU with the assistance of a thread hinting framework 140 as described above in connection with FIG. 1. If a thread hinting framework 140 is not present, then the CFS 145 will perform this step 310 entirely on its own.

Next, in step 315, for a re-occurring predetermined time period while the gaming application 135 is running on the PCD 500 (i.e. every 8 ms for a refresh rate @ 120 Hz, or as another example, about every 100.0 milliseconds), a ranking (i.e. an ordered list) of the high priority heavy threads is created by the CFS 145 according to each heavy thread's workload levels. A heavy thread workload history in this step 315 may be maintained by the CFS 145. For the example described in FIG. 1, the three threads N, N−1, & N−2 would be ranked/put in a prioritized order with the heaviest thread having the highest priority and the lightest thread having the lowest priority.

Also in this step 315, the CFS 145 also determines the present workload of each CPU core that includes BIG core CPUs 114, 116, 121 as well as PRIME cores CPUs 119, 119A, 119B (if any PRIME cores exist). The CFS 145 during this step 315 also creates a ranking of each CPU core 114, 116, 121, 119, 119A, and 119B based on their present workload level.

Subsequently, in decision step 320, it is determined if there are one or more than one Prime CPU worthy pipeline threads.

As illustrated in FIGS. 2A and 2C, these diagrams show big-CPU clusters 104 (FIG. 2A) or 104 (FIG. 2C) that have one or more prime cores 119. As described previously, the highest capacity big-CPU 119 of big-CPU cluster 104 of FIG. 2A is the generally a prime CPU-core 119. The prime CPU-core 119, 119A, 119B of the big-CPU cluster 104 is usually the one that also gives the best CPU IPC for a given CPU workload at ISO-CPU frequency across all the other big cores 114, 116 in the CPU cluster 104. The CPU prime core 119, 119A, 119B usually has a higher CPU-fMax corner (i.e., the maximum allowed CPU frequency) compared to other big-CPUs 114, 116 in the CPU subsystem/architecture 104.

Meanwhile, the CPU subsystem/architecture 104′ of FIG. 2B does not have a prime core 119 (see FIG. 2A). Instead, the CPU architecture 104′ of FIG. 2B has three big-CPU cores 114, 116, & 121, compared to the CPU architecture 104 of FIG. 2A which has two big-CPU cores 114, 116. As noted previously, the method 100 and system 101 are not limited to the number of cores 108, 110, 114, 116, 119, 119A, 119B 121, 120, 122 illustrated in FIGS. 2A-2C. Fewer or a greater number of cores, including prime cores 119, 119A, 119B may be employed without departing from this disclosure.

This decision step 320 is dependent on the type of CPU architecture 104, 104′ being employed. If the CPU architecture having prime CPU cores 119, 119A, 119B is present, then the method 101A of FIG. 3A follows the “YES” branch from decision step 320 to Step 325. If the CPU architecture 104′ which does not have any prime cores but only big-CPU cores 114, 116 & 121 is employed, then the method 101A of FIG. 3A follows the “NO” branch from decision step 320 to Step 330.

In step 325, the method 101A of FIG. 3A then continues to step 335 of FIG. 3B-1. Meanwhile, in step 330, the method 101A of FIG. 3A then continues to step 365 of FIG. 3C.

Referring now to FIG. 3B-1, this figure illustrates a continuation flowchart of the method 101A of FIG. 3A for prioritizing and assigning pipeline threads A, B, or C to single dedicated cores 114, 116, 119, 119A, 119B, 121 of a CPU architecture 104, 104′ during a vSync window 77. Decision step 335 is the first step of method 101B listed in FIG. 3B-1 and is followed from step 325 of FIG. 3A.

In decision step 335, the CFS 145 determines if there are one (FIG. 2A) or more than one (FIG. 2C) unassigned Prime CPU-cores 119, 119A, 119B. If the inquiry to decision step 335 is negative, then the “No” branch is followed to step 339, in which the method 101B proceeds to Step 365 of FIG. 3C.

However, if the inquiry to decision step 335 is positive, then the “Yes” branch is followed to decision step 350. In decision step 350, the CFS 145 iterates over (goes through each of) the list of PRIME worthy unassigned pipeline threads.

Next, in decision step 351, for a particular PRIME worthy thread, the CFS 145 determines if a current PRIME worthy thread has been assigned to a PRIME CPU 119, 119A, 119B. If the inquiry to decision step 351 is negative, then the “No” branch is followed to step 353. If the inquiry to decision step 351 is positive, then the “Yes” branch is followed to step 352.

In step 352, the CFS 145 uses the same PRIME CPU 119, 119A, 119B to the current PRIME worthy thread in order to avoid frequent task migration. The method 101B then proceeds back to step 350.

Meanwhile, in step 353 which is the result of the “No” branch of decision step 351, the CFS 145 may place the heaviest of the PRIME worth pipeline threads onto a PRIME CPU 119, 119A, 119B that has not already been assigned a pipeline thread. Among the group of unassigned PRIME CPUs 119, 119A, 119B, the PRIME CPU 119, 119A, 119B which has the least load may be selected. During this step 353, the CFS 145 may create a ranking of PRIME CPUs 119, 119A, 119B according to their present/current workload levels. And the PRIME CPU 119, 119A, 119B which is least loaded may be selected in this step 353. With step 353, PRIME CPU cores 119, 119A, 119B with lighter workload levels receive higher priority threads having higher workload levels, and PRIME CPU cores 119, 119A, 119B with heavier workload levels receive lower priority threads having lighter workload levels.

Next, in decision step 354, the CFS 145 may determine if there are any remaining PRIME worthy unassigned pipeline threads and if there is an unassigned PRIME CPU Core 119 available to be assigned by the CFS 145. If the inquiry to decision step 354 is positive, then the “YES” branch is followed back to step 350, where the CFS 145 iterates/reviews the list of PRIME worthy pipeline threads to determine which ones have not been assigned. If the inquiry to decision step 354 is negative, then the “NO” branch is followed to step 355.

In step 355, the CFS 145 iterates it list of pipeline threads which have not been assigned a BIG CPU 114, 116, 121. Subsequently, in decision step 356, the CFS 145 looking at a particular pipeline thread from its list, determines if it has been assigned to a BIG CPU 114, 116, 121. If the inquiry to decision step 356 is positive, the method 101B follows the “YES” branch and continues to step 357. If the inquiry to decision step 356 is negative, then the “NO” branch is followed to step 358.

In step 357, the CFS 145 uses the same BIG CPU 114, 116, 121 already assigned to the present pipeline thread to avoid frequent task migration. The method 101B then continues back to step 355 where the CFS 145 iterates over its list to identify those threads which have not been assigned to a BIG CPU 114, 116, 121.

In step 358, flowing from the “No” branch of decision step 356, the CFS 145 may place the next heaviest of the pipeline threads onto a BIG CPU 114, 116, 121 that has not already been assigned to a pipeline thread. Among the group of unassigned BIG CPUs 114, 116, 121 which has the least load may be selected. During this step 358, the CFS 145 may create a ranking of BIG CPUs 114, 116, 121 according to their present/current workload levels. And the BIG CPU 114, 116, 121 which is least loaded may be selected in this step 358. After step 358, the method 101B flows to step 359 of FIG. 3B-2.

Referring now to FIG. 3B-2, this figure illustrates a continuation flowchart of the method 101B of FIG. 3B-1 for prioritizing and assigning pipeline threads to single dedicated cores of a CPU architecture during a vSync window. Decision Step 359 is the first step of FIG. 3B-2. Decision step 359 is reached from step 358 of FIG. 3B-1 described above.

In decision step 359, the CFS 145 determines if there are any remaining pipeline treads to be assigned to a BIG CPU 114, 116, 121. If the inquiry to decision step 359 is positive, then the “YES” branch is followed back to step 355 of FIG. 3B-1. If the inquiry to decision step 359 is negative, then the “NO” branch is followed to decision step 361.

In decision step 361, the CFS 145 at the end of the vSync window/scheduler accounting time period determines if all the threads (N, N−1, N−2—FIG. 1) have completed their workload (i.e. no more frames to render for the application). If the application 135 has more frames to render on the display device 514, then the “YES” branch is followed to decision step 362. Otherwise, if the CFS 145 at the end of the vSync window determines all the threads (N, N−1, N−2—FIG. 1) have completed their workload, then the method 101B may follow the “NO” branch from decision step 361 where the method 101B then ends and/or may return to step 305 of FIG. 3A.

In decision step 362, it is determined if the re-occurring predetermined time period of step 315 (when the ranking of the high priority threads was created) has ended. If the time period has not expired, then the “No” branch is followed back to decision step 361 described above. If the time period has expired, then the “Yes” branch is followed to Step 363, which takes the method 101C back to step 315 of FIG. 3A.

Referring now to FIG. 3C, this figure illustrates a continuation flowchart of the method 101A of FIG. 3A for prioritizing and assigning pipeline threads A, B, or C to single dedicated cores 114, 116, 119, 121 of a CPU architecture 104, 104′ during a vSync window 77. Step 365 is the first step of method 101C listed in FIG. 3B and is followed from step 330 of FIG. 3A OR step 339 of FIG. 3B-1.

In step 365, the CFS 145 iterates over the list of unassigned BIG worthy pipeline threads. This step 365 is similar to step 355 of FIG. 3B-1.

Subsequently, in decision step 370, for each BIG worthy pipeline thread, the CFS 145 determines if it has already been assigned to a BIG CPU 114, 116, 121. If the inquiry to decision step 370 is positive, then the “YES” branch is followed to step 371. If the inquiry to decision step 370 is negative, then the “NO” branch is followed step 373.

In step 371, the CFS 145 uses the same BIG CPU already assigned to a particular BIG CPU 114, 116, 121 to avoid task migration. And the method 101C continues back to step 365 where the CFS 145 looks for unassigned BIG worthy pipeline threads.

In step 373, which is the result of the “No” branch of decision step 370, the CFS 145 may place the next heaviest of the BIG worthy pipeline threads onto a BIG CPU 114, 116, 121 that has not already been assigned to a pipeline thread. This step 373 is similar to step 358 of FIG. 3B-1 described above. Among the group of unassigned BIG CPUs 114, 116, 121 which has the least load may be selected.

During this step 373 of FIG. 3C, the CFS 145 may create a ranking of BIG CPUs 114, 116, 121 according to their present/current workload levels. And the BIG CPU 114, 116, 121 which is least loaded (has the least load) may be selected in this step 373. After step 373, the method 101B flows to decision step 374 of FIG. 3C. With step 373, BIG CPU cores 114, 116, 121 with lighter workload levels receive higher priority threads having higher workload levels, and BIG CPU cores 114, 116, 121 with heavier workload levels receive lower priority threads having lighter workload levels.

In decision step 374 of FIG. 3C, the CFS 145 determines if there are any remaining BIG worthy pipeline treads to be assigned to a BIG CPU 114, 116, 121. This step 374 is similar to step 359 of FIG. 3B-2. If the inquiry to decision step 374 is positive, then the “YES” branch is followed back to step 365 of FIG. 3C. If the inquiry to decision step 374 is negative, then the “NO” branch is followed to decision step 381.

Subsequently, in decision step 381, the CFS 145 at the end of the vSync window determines if all the threads (N, N−1, N−2—FIG. 1) have completed their workload (i.e. no more frames to render for the application). If the application has more frames to render on the display device 514, then the “YES” branch is followed to decision step 382.

Otherwise, if the CFS 145 at the end of the vSync window determines all the threads (N, N−1, N−2—FIG. 1) have completed their workload, then the method 101C of FIG. 3C may follow the “NO” branch from decision step 381 where the method 101C then ends and/or may return to step 305 of FIG. 3A.

In decision step 382, it is determined if the re-occurring predetermined time period of step 315 (when the ranking of the high priority threads was created) has ended. If the time period has not expired, then the “No” branch is followed back to decision step 381 described above. If the time period has expired, then the “Yes” branch is followed to Step 383, which takes the method 101C back to step 315 of FIG. 3A.

Referring now to FIG. 4A, this illustrates CPU utilization for two big-CPU cores 114, 116 and a single prime core 119 of FIG. 2A using a conventional thread assignment technology. Meanwhile, FIG. 4B illustrates CPU utilization for two big-CPU cores 114, 116 and a single prime core 119 of FIG. 2A using the method of FIG. 3.

The Y-axis for FIGS. 4A-4B is CPU utilization on a CPU core (ranges from 0-1024; higher CPU utilization corresponds to higher CPU frequency), where the X-axis of FIGS. 4A-4B may denote elapsed time usually in seconds. FIG. 4A shows how CPU utilization for pipeline threads managed by conventional thread assignment techniques is significantly higher and noisy as compared to the CPU utilization shown in FIG. 4B.

As shown in FIG. 4B, the method 101 typically lowers CPU utilization 400B greatly for each big-CPU core 114, 116. Meanwhile, the method 101 slightly increases the CPU utilization 400B for the prime core 119 compared to conventional thread assignments (compare the utilization chart for the prime core 119 of FIG. 4A with the utilization chart for the prime core 119 of FIG. 4B). That is, conventional pipeline thread assignment techniques of FIG. 4A may under-utilize the prime core 119, while the method 101 of FIG. 3 uses the prime core 119 at a slightly higher workload level without maximizing its utilization.

Random spikes in CPU utilization shown in FIG. 4A have been substantially reduced and/or eliminated as shown in FIG. 4B. FIG. 4B shows how the two big-CPU cores 114, 116 can execute the same pipeline threads at a much lower frequency compared to the CPU frequency shown in FIG. 4A.

Referring now to FIG. 5, this figure illustrates an example of a PCD 500, such as a mobile telephone, a portable digital assistant (PDA), a portable game console, a VR console, a palmtop computer, or a tablet computer. The PCD 500 executes the method of FIG. 3 for prioritizing and assigning pipeline threads N, N-1, N-2 (FIG. 1) to single dedicated cores 104 of its CPU architecture 504 during a vSync window.

The PCD 500 may comprise the multi-cluster heterogeneous processor architecture of FIGS. 2A-2B which includes a plurality of processor clusters 102, 104, 106, Nth cluster controlled by the HLOS. For purposes of clarity, some interconnects, signals, etc., are not shown in FIG. 5.

The PCD 500 may include an SoC 502. The SoC 502 may include a CPU 504, a neural processing unit (NPU) 505 (for artificial intelligence (AI) components), a graphics processing unit (GPU) 506, a digital signal processor (DSP) 507, an analog signal processor 508, a modem/modem subsystem 554, or other processors. The CPU 504 may include one or more CPU clusters 102, 104, 104′, and 106 as described above and illustrated in FIGS. 2A-2B.

The cores of clusters 102, 104, and 106 may be configured in the manner described above with reference to FIGS. 2A-2B and FIG. 3 to perform the operations described above of the pipeline thread assignment system and method of the present disclosure. The CPU clusters 102, 104, and 106 may also perform other operations of the type that they normally perform in a PCD 500.

Alternatively, or in addition, any of the processors, such as the NPU 505, GPU 506, DSP 507, etc., may have cores that are configured in the manner described above with reference to FIGS. 2A-2B and FIG. 3 to perform the operations described above of the pipeline thread assignment system and method of the present disclosure.

A display controller 509 and a touch-screen controller 512 may be coupled to the CPU 504. A touchscreen display 514 external to the SoC 502 may be coupled to the display controller 510 and the touch-screen controller 512. The display or display panel 514 may present the pipeline threads N, N-1, N-2 as illustrated in FIG. 1.

The PCD 500 may further include a video decoder 516 coupled to the CPU 504. A video amplifier 518 may be coupled to the video decoder 516 and the touchscreen display 514. A video port 520 may be coupled to the video amplifier 518. A universal serial bus (“USB”) controller 522 may also be coupled to CPU 504, and a USB port 524 may be coupled to the USB controller 522. A subscriber identity module (“SIM”) card 526 may also be coupled to the CPU 504.

One or more memories 144 (see also FIGS. 2A-2C) may be coupled to the CPU 504. The one or more memories 144 may include both volatile and non-volatile memories. Examples of volatile memories include static random access memory (“SRAM”) and dynamic random access memory (“DRAM”). Such memories may be external to the SoC 502 or internal to the SoC 502. The one or more memories 144 may include local cache memory or a system-level cache memory 112, 118, 124 as shown in FIGS. 2A-2B.

A stereo audio CODEC 534 may be coupled to the analog signal processor 508. Further, an audio amplifier 536 may be coupled to the stereo audio CODEC 534. First and second stereo speakers 538 and 540, respectively, may be coupled to the audio amplifier 536. In addition, a microphone amplifier 542 may be coupled to the stereo audio CODEC 534, and a microphone 544 may be coupled to the microphone amplifier 542.

A frequency modulation (“FM”) radio tuner 546 may be coupled to the stereo audio CODEC 534. An FM antenna 548 may be coupled to the FM radio tuner 546. Further, stereo headphones 550 may be coupled to the stereo audio CODEC 534. Examples of other devices that may be coupled to the CPU 504 include one or more digital (e.g., CCD or CMOS) cameras 552.

A modem or RF transceiver 554 may be coupled to the analog signal processor 508 and the CPU 504. An RF switch 556 may be coupled to the RF transceiver 554 and an RF antenna 558. In addition, a keypad 560 and a mono headset with a microphone 562 may be coupled to the analog signal processor 508. The SoC 502 can have one or more internal or on-chip thermal sensors 570 in addition to the thermal sensors that are located in or near the cores 5041-504M. A power supply 574 and a PMIC 576 may supply power to the SoC 502.

The completely fair scheduler 145 as illustrated in FIG. 5 (and in FIGS. 1-2B) may comprise software and/or firmware that is executed by the multicore CPU 504 which has the various CPU clusters 102, 104. Firmware or software may be stored in any of the above-described memories, or may be stored in a local memory directly accessible by the processor hardware on which the software or firmware executes.

Execution of such firmware or software may control aspects of any of the above-described methods or configure aspects of any of the above-described systems. Any such memory or other non-transitory storage medium having firmware or software stored therein in computer-readable form for execution by processor hardware may be an example of a “computer-readable medium,” as the term is understood in the patent lexicon.

In a particular aspect, one or more of the method steps described herein (such as illustrated in FIGS. 3A-3C) may be stored in the memory 144 as computer program instructions. These instructions may be executed by the digital signal processor or multi-core heterogenous central processing unit 504, a digital signal processor 507, or another processor, to perform the methods described herein. Further, the multicore CPU 504, the memory 144, the instructions stored therein, or a combination thereof may serve as a means for performing one or more of the method steps described herein.

Certain steps in the processes or process flows described in this specification naturally precede others for the invention to function as described. However, the invention is not limited to the order of the steps described if such order or sequence does not alter the functionality of the invention. That is, it is recognized that some steps may be performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium.

Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Implementation examples are described in the following numbered clauses.

1. A method for prioritizing and assigning threads in a CPU architecture, where the method includes:
receiving input to create frames on a display device of battery-powered portable computing device at a predetermined rate;
identifying threads of execution responsible for creating the frames and which correspond to a number of first CPU cores in the CPU architecture, the CPU
architecture comprising first CPU cores and second CPU cores, each first CPU core has a first processing capacity and each second CPU core has a second processing capacity, the first processing capacity being greater than the second processing capacity;
for a predetermined time period, creating a ranking of the threads according to their workload levels;
determining a present workload level of each first CPU core;
creating a ranking of the first CPU cores according to their present workload levels; and
assigning each thread to a single first CPU core according to the ranking of the first CPU cores and according to the ranking of the threads.

2. The method of clause 1, wherein first CPU cores with the lighter workload levels receive higher priority threads having higher workload levels, and first CPU cores with heavier workload levels receive lower priority threads having lighter workload levels.

3. The method of any of clauses 1-2, wherein the CPU architecture comprises a prime CPU core, and the method further comprises assigning the prime CPU core with a highest priority thread having a highest workload.

4. The method of any of clauses 1-3, further comprising: after assigning the prime CPU core with the highest priority thread having a highest workload, assigning any remaining ranked among the first CPU cores.

5. The method of any of clauses 1-4, wherein the predetermined time period comprises a multiple of a display device refresh rate.

6. The method of any of clauses 1-5, wherein a completely fair scheduler identifies the threads of execution responsible for creating the frames and which correspond only up to the number of first CPU cores in the CPU architecture.

7. The method of any of clauses 1-6, wherein the completely fair scheduler receives data about the threads of execution from a thread hinting framework.

8. The method of any of clauses 1-7, wherein a thread of execution assigned to a first CPU core will continue to use a same first CPU core until the thread gets ranked as the highest priority heaviest thread at the end of the predetermined time period at which point the highest priority thread will be moved onto a single prime core or one of multiple prime cores for a subsequent predetermined time period.

9. The method of any of clauses 1-8, wherein if a thread of execution is assigned to a first CPU core, then the thread will continue to use the same first CPU core until frame rendering is complete.

10. The method of any of clauses 1-9, wherein the battery-powered portable computing device comprises at least one of a: mobile telephone, a portable digital assistant (PDA), a portable game console, a VR console, a palmtop computer, or a tablet computer.

11. A system for prioritizing and assigning threads in a CPU architecture, the system including:
a scheduler for receiving input to create frames on a display device of battery-powered portable computing device at a predetermined rate, the scheduler identifying threads of execution responsible for creating the frames and which correspond to a number of first CPU cores in the CPU architecture, the CPU architecture comprising first CPU cores and second CPU cores, each first CPU core has a first processing capacity and each second CPU core has a second processing capacity, the first processing capacity being greater than the second processing capacity; and
wherein for a predetermined time period, the scheduler creating a ranking of the threads according to their workload levels; the scheduler determining a present workload level of each first CPU core; the scheduler creating a ranking of the first CPU cores according to their present workload levels; and the scheduler assigning each thread to a single first CPU core according to the ranking of the first CPU cores and according to the ranking of the threads.

12. The system of clause 11, wherein first CPU cores with the lighter workload levels receive higher priority threads having higher workload levels, and first CPU cores with heavier workload levels receive lower priority threads having lighter workload levels.

13. The system of any of clauses 11-12, wherein the CPU architecture comprises a single or multiple prime CPU cores, and the system further comprises the single prime core or one of the multiple prime CPU cores being assigned with a highest priority thread having a highest workload.

14. The system of any of clauses 11-13, further comprising: after assigning the single prime core or one of the multiple prime CPU cores with the highest priority thread having a highest workload, the scheduler assigning any remaining ranked among the first CPU cores.

15. The system of any of clauses 11-14, wherein the predetermined time period comprises a multiple of a display device refresh rate.

16. The system of any of clauses 11-15, wherein the scheduler identifies the threads of execution responsible for creating the frames and which correspond only up to the number of first CPU cores in the CPU architecture.

17. The system of any of clauses 11-16, wherein the scheduler receives data about the threads of execution from a thread hinting framework.

18. The system of any of clauses 11-17, wherein a thread of execution assigned to a first CPU core will continue to use a same first CPU core until the thread gets ranked as the highest priority heaviest thread at the end of the predetermined time period at which point the highest priority thread will be moved onto the single prime core or one of the multiple prime cores for a subsequent predetermined time period.

19. The system of any of clauses 11-18, wherein if a thread of execution is assigned to a first CPU core, then the thread will continue to use the same first CPU core until frame rendering is complete.

20. The system of any of clauses 11-19, wherein the battery-powered portable computing device comprises at least one of a: mobile telephone, a portable digital assistant (PDA), a portable game console, a VR console, a palmtop computer, or a tablet computer.

21. A system for prioritizing and assigning threads in a CPU architecture, the system including:
a scheduler configured to receive input to create frames on a display device of battery-powered portable computing device at a predetermined rate, the scheduler being further configured to identify threads of execution responsible for creating the frames and which correspond to a number of first processing means in the CPU architecture, the CPU architecture comprising first processing means and second processing means, each first processing means having a first processing capacity and each second processing means having a second processing capacity, the first processing capacity being greater than the second processing capacity; and
wherein for a predetermined time period, the scheduler is configured to create a ranking of the threads according to their workload levels; the scheduler being configured to determine a present workload level of each first processing means; the scheduler being configured to create a ranking of the first processing means according to their present workload levels; and wherein the scheduler is configured to assign each thread to a single first processing means according to the ranking of the first processing means and according to the ranking of the threads.

22. The system of clause 21, wherein first processing means and second processing means comprise at least one of: a central processing unit, a multicore processing unit, a digital signal processor, a graphics processing unit, and a combination thereof.

23. The system of clauses 21-22, wherein first processing means with the lighter workload levels receive higher priority threads having higher workload levels, and first processing means with heavier workload levels receive lower priority threads having lighter workload levels.

24. The system of clauses 21-23, wherein the CPU architecture comprises a single prime core or multiple prime CPU cores, and the system further comprises the single prime core or one of the multiple prime CPU cores being assigned with a highest priority thread having a highest workload.

25. A computer program product for prioritizing and assigning threads in a CPU architecture, the computer program product having a non-transitory computer-readable medium having stored thereon in computer-executable form instructions that when executed by CPU architecture configure the CPU architecture to:
receive input to create frames on a display device of battery-powered portable computing device at a predetermined rate;
identify threads of execution responsible for creating the frames and which correspond to a number of first CPU cores in the CPU architecture, the CPU architecture comprising first CPU cores and second CPU cores, each first CPU core has a first processing capacity and each second CPU core has a second processing capacity, the first processing capacity being greater than the second processing capacity;
for a predetermined time period, create a ranking of the threads according to their workload levels;
determine a present workload level of each first CPU core;
create a ranking of the first CPU cores according to their present workload levels; and
assign each thread to a single first CPU core according to the ranking of the first CPU cores and according to the ranking of the threads.

26. The computer program product of clause 25, wherein first CPU cores with the lighter workload levels receive higher priority threads having higher workload levels, and first CPU cores with heavier workload levels receive lower priority threads having lighter workload levels.

27. The computer program product of clauses 25-26, wherein the CPU architecture comprises a single prime CPU core or multiple prime CPU cores, and the method further comprises assigning the single prime CPU core or one of the multiple prime CPU cores with a highest priority thread having a highest workload.

28. The computer program product of clauses 25-27, wherein the instructions further configure the CPU architecture to: after assigning a prime CPU core with the highest priority thread having a highest workload, assigning any remaining ranked among the first CPU cores.

29. The computer program product of clauses 25-28, wherein the predetermined time period comprises a multiple of a display device refresh rate.

30. The computer program product of clauses 25-29, wherein the instructions further configure the CPU architecture to: identify the threads of execution responsible for creating the frames and which correspond only up to the number of first CPU cores in the CPU architecture.

Alternative embodiments will become apparent to one of ordinary skill in the art to which this disclosure pertains without departing from its scope. Therefore, although selected aspects have been illustrated and described in detail, it will be understood that various substitutions and alterations may be made therein without departing from the scope of this disclosure, as defined by the following claims.

What is claimed is:

1. A method for prioritizing and assigning threads in a CPU architecture, comprising:
receiving input to create frames on a display device of battery-powered portable computing device at a predetermined rate;
identifying threads of execution responsible for creating the frames and which correspond to a number of first CPU cores in the CPU architecture, the CPU architecture comprising first CPU cores and second CPU cores, each first CPU core has a first processing capacity and each second CPU core has a second processing capacity, the first processing capacity being greater than the second processing capacity;
for a predetermined time period, creating a ranking of the threads according to their workload levels;
determining a present workload level of each first CPU core;
creating a ranking of the first CPU cores according to their present workload levels; and
assigning each thread to a single first CPU core according to the ranking of the first CPU cores and according to the ranking of the threads.

2. The method of claim 1, wherein first CPU cores with the lighter workload levels receive higher priority threads having higher workload levels, and first CPU cores with heavier workload levels receive lower priority threads having lighter workload levels.

3. The method of claim 1, wherein the CPU architecture comprises a prime CPU core, and the method further comprises assigning the prime CPU core with a highest priority thread having a highest workload.

4. The method of claim 3, further comprising: after assigning the prime CPU core with the highest priority thread having a highest workload, assigning any remaining ranked among the first CPU cores.

5. The method of claim 1, wherein the predetermined time period comprises a multiple of a display device refresh rate.

6. The method of claim 1, wherein a completely fair scheduler identifies the threads of execution responsible for creating the frames and which correspond only up to the number of first CPU cores in the CPU architecture.

7. The method of claim 6, wherein the completely fair scheduler receives data about the threads of execution from a thread hinting framework.

8. The method of claim 4, wherein a thread of execution assigned to a first CPU core will continue to use a same first CPU core until the thread gets ranked as the highest priority heaviest thread at the end of the predetermined time period at which point the highest priority thread will be moved onto a single prime core or one of multiple prime cores for a subsequent predetermined time period.

9. The method of claim 1, wherein if a thread of execution is assigned to a first CPU core, then the thread will continue to use the same first CPU core until frame rendering is complete.

10. The method of claim 1, wherein the battery-powered portable computing device comprises at least one of a: mobile telephone, a portable digital assistant (PDA), a portable game console, a VR console, a palmtop computer, or a tablet computer.

11. A system for prioritizing and assigning threads in a CPU architecture, comprising:
a scheduler configured to receive input to create frames on a display device of battery-powered portable computing device at a predetermined rate, the scheduler being configured to identify threads of execution responsible for creating the frames and which correspond to a number of first CPU cores in the CPU architecture, the CPU architecture comprising first CPU cores and second CPU cores, each first CPU core having a first processing capacity and each second CPU core having a second processing capacity, the first processing capacity being greater than the second processing capacity; and
wherein for a predetermined time period, the scheduler is configured to create a ranking of the threads according to their workload levels; the scheduler being configured to determine a present workload level of each first CPU core; the scheduler being configured to create a ranking of the first CPU cores according to their present workload levels; and the scheduler being configured to assign each thread to a single first CPU core according to the ranking of the first CPU cores and according to the ranking of the threads.

12. The system of claim 11, wherein first CPU cores with the lighter workload levels receive higher priority threads having higher workload levels, and first CPU cores with heavier workload levels receive lower priority threads having lighter workload levels.

13. The system of claim 11, wherein the CPU architecture comprises a single or multiple prime CPU cores, and the system further comprises the single prime core or one of the multiple prime CPU cores being assigned with a highest priority thread having a highest workload.

14. The system of claim 13, further comprising: after assigning the single prime core or one of the multiple prime CPU cores with the highest priority thread having a highest workload, the scheduler assigning any remaining ranked among the first CPU cores.

15. The system of claim 11, wherein the predetermined time period comprises a multiple of a display device refresh rate.

16. The system of claim 11, wherein the scheduler identifies the threads of execution responsible for creating the frames and which correspond only up to the number of first CPU cores in the CPU architecture.

17. The system of claim 16, wherein the scheduler receives data about the threads of execution from a thread hinting framework.

18. The system of claim 14, wherein a thread of execution assigned to a first CPU core will continue to use a same first CPU core until the thread gets ranked as the highest priority heaviest thread at the end of the predetermined time period at which point the highest priority thread will be moved onto the single prime core or one of the multiple prime cores for a subsequent predetermined time period.

19. The system of claim 11, wherein if a thread of execution is assigned to a first CPU core, then the thread will continue to use the same first CPU core until frame rendering is complete.

20. The system of claim 11, wherein the battery-powered portable computing device comprises at least one of a: mobile telephone, a portable digital assistant (PDA), a portable game console, a VR console, a palmtop computer, or a tablet computer.

21. A system for prioritizing and assigning threads in a CPU architecture, comprising:
a scheduler for receiving input to create frames on a display device of battery-powered portable computing device at a predetermined rate, the scheduler identifying threads of execution responsible for creating the frames and which correspond to a number of first processing means in the CPU architecture, the CPU architecture comprising first processing means and second processing means, each first processing means has a first processing capacity and each second processing means has a second processing capacity, the first processing capacity being greater than the second processing capacity; and
wherein for a predetermined time period, the scheduler creating a ranking of the threads according to their workload levels; the scheduler determining a present workload level of each first processing means; the scheduler creating a ranking of the first processing means according to their present workload levels; and the scheduler assigning each thread to a single first processing means according to the ranking of the first processing means and according to the ranking of the threads.

22. The system of claim 21, wherein first processing means and second processing means comprise at least one of: a central processing unit, a multicore processing unit, a digital signal processor, a graphics processing unit, and a combination thereof.

23. The system of claim 21, wherein first processing means with the lighter workload levels receive higher priority threads having higher workload levels, and first processing means with heavier workload levels receive lower priority threads having lighter workload levels.

24. The system of claim 21, wherein the CPU architecture comprises a single prime core or multiple prime CPU cores, and the system further comprises the single prime core or one of the multiple prime CPU cores being assigned with a highest priority thread having a highest workload.

25. A computer program product for prioritizing and assigning threads in a CPU architecture, the computer program product comprising a non-transitory computer-readable medium having stored thereon in computer-executable form instructions that when executed by CPU architecture configure the CPU architecture to:
receive input to create frames on a display device of battery-powered portable computing device at a predetermined rate;
identify threads of execution responsible for creating the frames and which correspond to a number of first CPU cores in the CPU architecture, the CPU architecture comprising first CPU cores and second CPU cores, each first CPU core has a first processing capacity and each second CPU core has a second processing capacity, the first processing capacity being greater than the second processing capacity;
for a predetermined time period, create a ranking of the threads according to their workload levels;
determine a present workload level of each first CPU core;
create a ranking of the first CPU cores according to their present workload levels; and
assign each thread to a single first CPU core according to the ranking of the first CPU cores and according to the ranking of the threads.

26. The computer program product of claim 25, wherein first CPU cores with the lighter workload levels receive higher priority threads having higher workload levels, and first CPU cores with heavier workload levels receive lower priority threads having lighter workload levels.

27. The computer program product of claim 26, wherein the CPU architecture comprises a single prime CPU core or multiple prime CPU cores, and the method further comprises assigning the single prime CPU core or one of the multiple prime CPU cores with a highest priority thread having a highest workload.

28. The computer program product of claim 27, wherein the instructions further configure the CPU architecture to: after assigning a prime CPU core with the highest priority thread having a highest workload, assigning any remaining ranked among the first CPU cores.

29. The computer program product of claim 27, wherein the predetermined time period comprises a multiple of a display device refresh rate.

30. The computer program product of claim 27, wherein the instructions further configure the CPU architecture to: identify the threads of execution responsible for creating the frames and which correspond only up to the number of first CPU cores in the CPU architecture.
